(19) United States
(12) Patent Application Publication
(10) Pub. No.: US 2020/0292723 A1
(43) Pub. Date: Sep. 17, 2020

(54) Method and Apparatus for Automatically Detecting Faults Using Deep Learning

(71) Applicant: BP Corporation North America Inc., Houston, TX (US)

(72) Inventors: Qie ZHANG, Houston, TX (US); Yunzhi Shi, Austin, TX (US); Anar Yusifov, Houston, TX (US)

(73) Assignee: BP Corporation North America Inc., Houston, TX (US)

(21) Appl. No.: 16/811,708

(22) Filed: Mar. 6, 2020

Related U.S. Application Data
(60) Provisional application No. 62/817,338, filed on Mar. 12, 2019.

(51) Int. Cl. G01V 1/30; G06N 3/08

(52) U.S. Cl. CPC G01V 1/301; G01V 2210/642; G06N 3/08

(57) ABSTRACT

A method includes receiving image data that is to be recognized by the at least one neural network. The image data is representative of a fault within a subsurface volume. The image data includes three-dimensional synthetic data. The method also includes generating an output via the at least one neural network based on the received image data. The method also includes comparing the output of the at least one neural network with a desired output; and modifying the neural network so that the output of the neural network corresponds to the desired output.

This application claims priority to U.S. Provisional patent application No. 62/817,338, filed with the United States Patent and Trademark Office on Mar. 12, 2019 and entitled “Method and Apparatus for Automatically Detecting Faults,” the disclosure of which is incorporated herein by reference in its entirety.

### BACKGROUND

The present disclosure relates generally to analyzing seismic data, and more specifically, to detecting faults in prediction of reservoir properties.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A seismic survey includes generating an image or map of a subsurface region of the Earth by sending sound energy down into the ground and recording the reflected sound energy that returns from the geological layers within the subsurface region. During a seismic survey, an energy source is placed at various locations on or above the surface region of the Earth, which may include hydrocarbon deposits. Each time the source is activated, the source generates a seismic (e.g., sound wave) signal that travels downward through the Earth, is reflected, and, upon its return, is recorded using one or more receivers disposed on or above the subsurface region of the Earth. The seismic data recorded by the receivers may then be used to create an image or profile of the corresponding subsurface region.

Upon creation of an image or profile of a subsurface region, these images and/or profiles can be used to interpret characteristics of a formation (such as, the faults of a formation, for example). Identifying faults in seismic images is important for the oil and gas industry. Faults can be both seal zones which trap hydrocarbons and baffle zones that cause reservoir compartmentalization. Therefore, fault interpretation is an important process in both exploration and reservoir development. However, current fault interpretation techniques can be labor intensive, costly, and/or time consuming.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In the course of interpreting images to identify hydrocarbon deposits, interpreters attempt to identify subsurface faults. Faults are generally understood as being a discontinuity in a portion of rock, where the discontinuity may be caused by subsurface movement, for example.

Interpreters seek to identify faults because identifying the location of faults can aid in identifying oil/gas traps. For example, direct hydrocarbon indicators can be located against/near faults in certain regions. Further, interpreters seek to identify faults because fault detection can be important for reservoir modelling and well planning. For example, certain faults can create drilling hazards.

Fault identifying/mapping can be a labor-intensive process. As such, it may be desirable to speed up the mapping of faults so that interpreters can look at each reservoir more quickly, and so that interpreters can look at more reservoirs.

In view of the above, one or more embodiments of the present invention are directed to performing automated fault detection. One or more embodiments can perform automated fault detection within a three-dimensional subsurface volume. One or more embodiments can implement fault detection by using deep learning.

### BRIEF DESCRIPTION OF THE DRAWINGS

Various aspects of this disclosure may be better understood upon reading the following detailed description and upon reference to the drawings in which:

FIG. 1 illustrates a flow chart of various processes that may be performed based on analysis of seismic data acquired via a seismic survey system;

FIG. 2 illustrates a marine survey system in a marine environment;

FIG. 3 illustrates a land survey system in a land environment;

FIG. 4 illustrates a computing system that may perform operations described herein based on data acquired via the marine survey system of FIG. 2 and/or the land survey system of FIG. 3;

FIG. 5 illustrates a flow chart of a method that implements one or more embodiments;

FIG. 6 illustrates an example of the implementation of the method of FIG. 5;

FIG. 7 illustrates an embodiment of a neural network of FIG. 6; and

FIG. 8 illustrates an embodiment of a Convolutional Neural Network (CNN) architecture that can be used in conjunction with FIG. 7.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

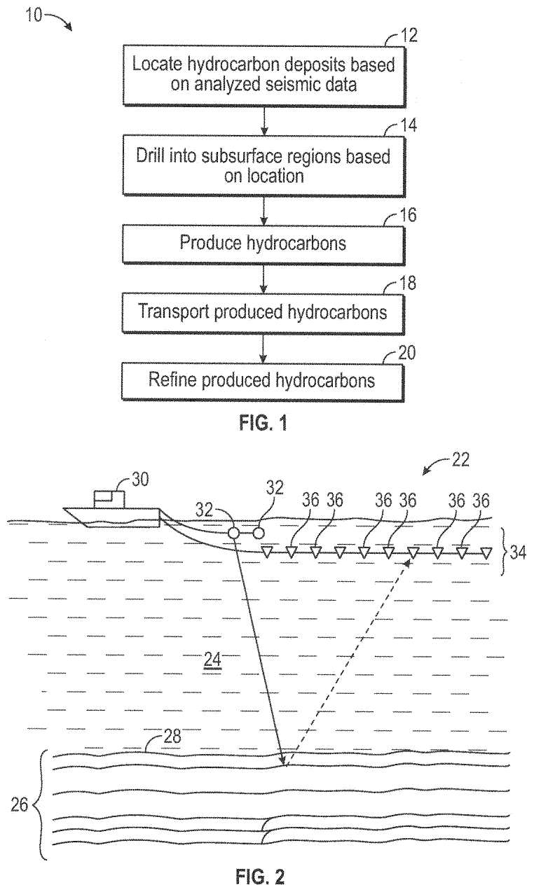

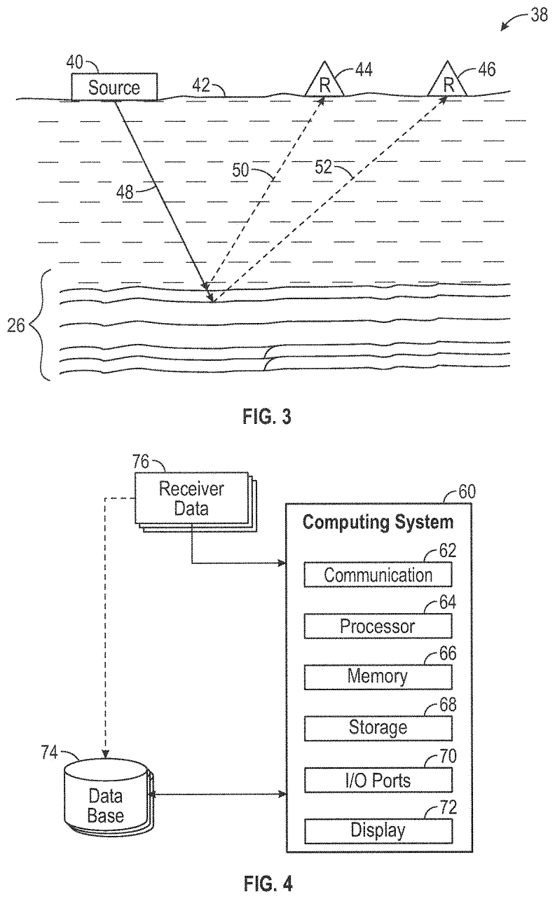

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc.) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations and acquired or recorded by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code or instructions to implement the methods described herein. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

With one or more embodiments, processor 64 can instantiate or operate in conjunction with one or more neural networks. The one or more neural networks can be software-implemented or hardware-implemented. One or more of the neural networks can be a convolutional neural network.

With one or more embodiments, these neural networks can provide responses to different inputs. The process by which a neural network learns and responds to different inputs may be generally referred to as a “training” process.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

In some embodiments, the results of the seismic data analysis may be generated in conjunction with a seismic processing scheme that includes seismic data collection, editing of the seismic data, initial processing of the seismic data, signal processing, conditioning, and imaging (which may, for example, include production of imaged sections or volumes) in prior to any interpretation of the seismic data, any further image enhancement consistent with the exploration objectives desired, generation of attributes from the processed seismic data, reinterpretation of the seismic data as needed, and determination and/or generation of a drilling prospect or other seismic survey applications. As a result, location of hydrocarbons within a subsurface region 26 may be identified. Techniques for detecting subsurface features (such as, for example, faults) from the seismic data/images will be described in greater detail below.

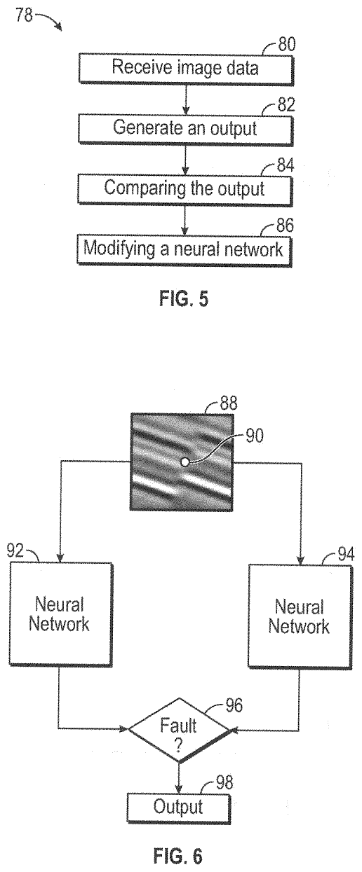

FIG. 5 illustrates a flow chart of a method 78 that implements a method of one or more embodiments. The method 78 of one or more embodiments can be performed by the computing system 60 of FIG. 4, for example by the processor 64 operating in conjunction with at least one of the memory 66 or the storage 68, for example, by executing code or instructions to carry out the steps of method 78.

The method 78, at step 80, illustrates reception of image data by the computing system 60 that is to be recognized by at least one neural network. The image data can be representative of a fault within a subsurface volume. Specifically, the image data can be representative of one fault, multiple faults, and/or no faults. The image data can, for example, include three-dimensional synthetic data. The method 78, at step 82, includes generating an output via the at least one neural network based on the received image data. The method 78, at step 84, can include comparing the output of the at least one neural network with a desired output. The method 78 can also include modifying the neural network so that the output of the neural network corresponds to the desired output in step 86. FIG. 6 illustrates an example of an implementation of at least a portion of method 78.

FIG. 6 illustrates the use of deep learning in conjunction with fault identification in a seismic image and may be performed, for example, by the computing system 60 of FIG. 4. More particularly, the processor 64 operating in conjunction with at least one of the memory 66 or the storage 68, for example, by executing code or instructions to carry out the techniques described below described in conjunction with FIG. 6.

Image 88 represents a two dimensional (2D) slice of a three dimensional (3D) image cube that will be processed as a portion of a seismic image being processed to determine fault locations therein. Thus, image 88 is presented as a 2D slice merely for ease of illustration; however, it should be understood that a 3D image cube can replace image 88 and that this 3D image cube (as well as the image 88, as illustrated) can each respectively correspond to the image data received in step 80 of method 78 in FIG. 5.

Image 88 includes center point 90. Fault prediction can be treated as an image classification problem, whereby the neural networks 92 and 94 classify only a particular location (e.g., the center point 90) of an image/cube (e.g., image 88) as indicative of a fault or not. When predicting faults using this technique, (e.g., a center point classifier), a sliding window is moved across a whole of the seismic image to be processed, typically voxel by voxel (or pixel by pixel). As illustrated, the image 88 is processed via (a first) neural network 92 and (a second) neural network 94. These neural networks 92 and 94 may be separate neural networks each assigned to predict one unique aspect of a potential fault in the image 88, for example, simultaneously (e.g., at the same time, nearly at the same time, or in parallel) or one after another (e.g., sequentially or in series). Alternatively, the neural networks 92 and 94 may be portions of a single neural network, whereby the portions corresponding to neural networks 92 and 94 are each assigned to predict one aspect of a potential fault in the image 88, for example, simultaneously (e.g., at the same time, nearly at the same time, or in parallel) or one after another (e.g., sequentially or in series).

It is envisioned that, for example, neural network 92 can predict and generate as an output the dip (e.g., the angle of a fault relative to a horizontal plane) of a fault located at or about the center point 90 as a portion of step 82 of FIG. 5. Additionally, for example, neural network 94 can predict and generate as an output the azimuth (e.g., the angle characterizing direction of the fault with respect to a reference direction) of a fault located at or about the center point 90 as a portion of step 82 of FIG. 5. Furthermore, additional attributes of the fault located at or about the center point 90 can be generated by additional neural networks and/or alternative attributes can be generated by the neural networks 92 and 94 as a portion of step 82 of FIG. 5. With one or more embodiments, the dip and azimuth attributes can be attributes which are necessary for defining a planar orientation of a predicted fault.

As further illustrated in FIG. 6, the computing system 60, in conjunction with step 84 of FIG. 5, determines whether a fault is present or is not present at or about the center point 90 in step 96. If the output of the neural network 92 indicates the presence of a fault, at least one attribute (e.g., dip, and/or azimuth) of that fault is transmitted in conjunction with an indication of a fault in image 88 or as indicative of the presence of a fault in image 88. If the output of the neural network 92 does not indicate the presence of a fault (i.e., if the neural network 92 does not determine that a fault is present in image 88), a negative indication thereof (e.g., a zero, a no, or another negative indicator) is transmitted. As discussed above, with one or more embodiments, the output of the neural network 92 can indicate whether or not a fault is present at a center point of image 88.

If the output of the neural network 94 indicates the presence of a fault, at least one attribute (e.g., azimuth) of that fault is transmitted in conjunction with an indication of a fault in image 88 or as indicative of the presence of a fault in image 88. If the output of the neural network 94 does not indicate the presence of a fault (i.e., if the neural network 94 does not determine that a fault is present in image 88 or at the center of image 88), a negative indication thereof (e.g., a zero, a no, or another negative indicator) is transmitted. In step 96, if either or both of the indications received as outputs from the neural networks 92 and 94 are negative indications, in step 96, the computing system 60 determines that no fault is present in image 88 (at the center point), as a portion of step 84 of FIG. 5, and the computing system 60 generates an output 98 indicating (e.g., classifying) image 88 as having no fault (at the center point).

However, if the output from both of the neural network 92 and the neural network 94 indicate the presence of a fault (at the center point), the computing system 60 determines that a fault is present in image 88, as a portion of step 84 of FIG. 5, and the computing system 60 generates an output 98 indicating (e.g., classifying) image 88 as having a fault (with the respective aspects, such as dip and azimuth, corresponding to the fault). Thus, a center point 90 of an image 88 is determined to be a fault (or have a fault therein) when both the neural network 92 and the neural network 94 vote yes (i.e., each indicate the presence of a fault). Thereafter, in some embodiments, a probability can be assigned to the fault, for example, the average of the predicted dip and azimuth probabilities from those two neural networks 92 and 94. One or more embodiments can output a dip and an azimuth at the same time.

This process is repeated for additional images 88 (e.g., additional voxels of the seismic image being processed) until the seismic image of interest is processed to reveal the faults present therein. Through the use of more than one neural network (e.g., neural network 92 and neural network 94) each designed to determine an distinct aspect of a fault as indicative of the presence of a fault, increased reliability of fault detection is established.

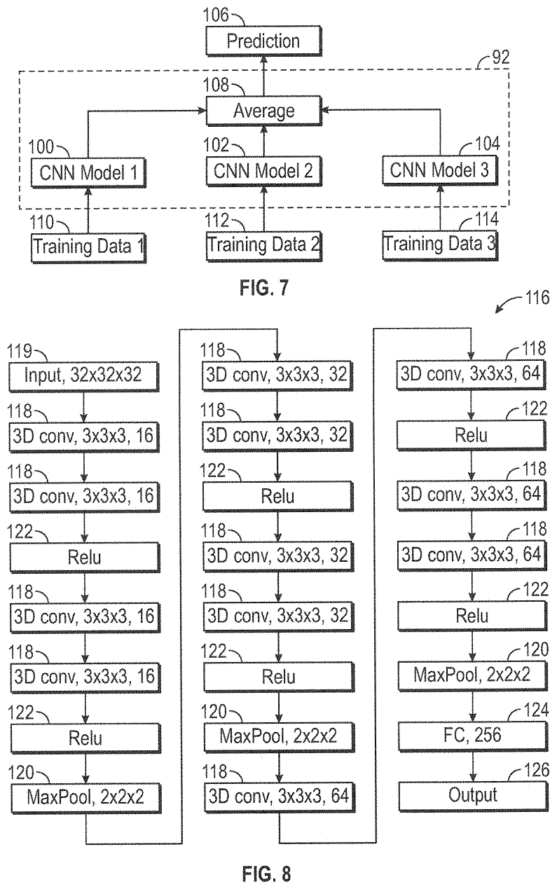

FIG. 7 illustrates an example of the neural network 92. The neural network 92 operates as a deep learning network. Deep learning methods implemented via a deep learning network can directly map the relationship between an image (e.g., image 88) and its corresponding label, for example, a fault or not. Different from the attribute methods, the feature maps in deep learning are derived by machines automatically through iterations, instead of engineered by humans. With the “self-learning” capability, deep learning can easily contain and handle millions of parameters, allowing it to learn very complex mapping relationships. Particularly, as one of the major deep learning methods, Convolutional Neural Networks (CNNs) are proven to be state-of-art for computer vision problems, including image classification, localization and segmentation. Accordingly, in present embodiments, one or more CNNs are utilized as the deep learning network of neural network 92.

The neural network 92 is illustrated as utilizing an ensemble of multiple CNN models 100, 102, and 104. While a single CNN model 100 may be used, the use of more than one CNN model 100 and 102, or CNN models 100, 102, and 104, or more than three CNN models may result in increased stability of the prediction 106 (e.g., output) generated by the neural network 92. With one or more embodiments, as reflected by experimental results, the number of CNN models within neural network 92 can be three models, in order to increase accuracy, while also keeping the computational cost from being too high. This, in turn, may operate to enhance fault predictions. Due to the diversification/independent nature of each individual CNN model 100, 102, and 104, an ensemble of multiple CNN models 100, 102, and 104 often outperforms a single CNN model, as the individual CNN models 100, 102, and 104 can complement each other. However, it should be noted that an ensemble can also add significant extra computation time. Accordingly, selection of the number of CNN models in an ensemble (or the use of an ensemble at all), may be altered based on the desire for rapid results, the desire for accuracy in the prediction 106 that is generated, cost and/or complexity considerations, among other factors.

The prediction 106 generated by the neural network 92 may have a set number of output categories. For example, the neural network 92 (e.g., calculating dip) has 26 output categories (a non-fault bin and 25 dip bins, each centered at 15°, 18°, 21°, . . . , and 87°, with a dip bin size 3°). With one or more embodiments, as reflected by experimental results, a dip bin size of 3° provided results which were practically accurate, while not needing computational costs that were too high. Thus the prediction 106 from neural network 92 will have a result indicative of no fault being present or a dip value centered at one of the above noted angles. The bin size and, thus, the total number of output categories of the neural network 92 may be chosen based on desired granularity of the result chosen; however, this choice may invoke cost/complexity considerations and/or other factors.

Furthermore, it should be noted that the structure of the neural network 92 (having individual CNN models 100, 102, and 104) may be repeated for neural network 94. However, as will be discussed in detail below, the training of the CNN models 100, 102, and 104 of neural network 92 differ from the training of CNN models of neural network 94. Additionally, since the neural network 94 has a different fault attribute output (e.g., azimuth) with respect to prediction 106 (dip) of neural network 92, the neural network 94 also will have different output categories with respect to neural network 92 discussed above.

For example, the neural network 94 (e.g., calculating azimuth) has 37 output categories (a non-fault bin plus 36 azimuth bins centered at 5°, 15°, 25°, . . . , and 355°, with a azimuth bin size 10°). Thus the prediction from neural network 94 will have a result indicative of no fault being present or an azimuth value centered at one of the above noted angles. The bin size and, thus, the total number of output categories of the neural network 94 may be chosen based on desired granularity of the result chosen; however, this choice may invoke cost/complexity considerations or other factors.

The outputs generated by the CNN models 100, 102, and 104 can be averaged in step 108 to generate the prediction 106 of the neural network 92. This averaging in step 108 may be a simple average of the outputs of CNN models 100, 102, and 104 or one or more of the outputs of the CNN models 100, 102, and 104 can be weighted (e.g., with respect to one another or with respect to one or more default weighting values). Similar averaging can be applied in neural network 94.

As noted above, the training of the CNN models 100, 102, and 104 of neural network 92 differ from the training of CNN models of neural network 94. One or more embodiments can use different training data when training different CNN models. Additionally, the training of the CNN models 100, 102, and 104 of neural network 92 differ from one another and the training of CNN models of neural network 94 differ from one another. For example, FIG. 7 illustrates training data 110, training data 112, and training data 114. Each of the training data 110, training data 112, and training data 114 differs from one another, which causes the CNN models 100, 102, and 104 of neural network 92 to process the image 88 and generate results that differ from one another slightly. In deep learning, it is key to carefully design and collect training data. A deep learning algorithm for fault detection demands a significant amount of training data to represent as many of the geologic scenarios as possible. CNN tends to perform poorly in the situations it has not seen in its training data pool. For example, CNN will not be able to predict steep dip faults if the training data only contains gentle to medium dip faults.

In present embodiments, the training data 110, training data 112, and training data 114 is 3D synthetic training data; however, actual recorded data, for example, from previous expeditions could be used in place of or in conjunction with the synthetic data. Benefits from the use of synthetic data for training include no human labeling required, reduction/elimination of manually labeled fault dips and azimuths in 3D field data, unlimited possibilities for the number of training data and labels, ease in populating all possible fault dips and azimuths, known ground truth labels, avoidance of existing manual selections that often following fault truncations inaccurately (rendering them inadequate for training). The training data 110, 112, and 114 is selected to allow its corresponding CNN model 100, 102, and 104 generalize better to field data. For example, the training data 110, 112, and 114 includes low angle faults (although infrequent), and therefore, expands fault dips in training data 110, 112, and/or 114 to values included in the range of, for example, approximately 13.5° to 88.5°. Additional filtering can be applied thereafter. For example, in the case where there is only interest in medium to high dip faults, the low dip faults can be selected and removed after inference. Similarly, the fault azimuth is another parameter, which is left to span the full range of approximately 0° to 360° for synthetic training data for neural network 94.

An important consideration in training data generation is the shape or slope of the horizons adjacent to faults. Although horizons are usually flat or gently dipping, it has been found to be useful to include horizons with all possible dips. Therefore, steep and almost vertical horizons are included in the training data 110, 112, and 114. This can operate to reduce the misclassification of a steep dipping horizon as a fault plane as well as mitigate false fault predictions in noisy seismic sections where steep noise and migration swings mislead the classifier. By improving the variability of instances in the training data 110, 112, and 114, the training data 110, 112, and 114 expands to frequencies inclusive of both low and high extremes for the seismic reflectors (produced from hundreds of thousands of randomly populated reflectivity models), and at the same time, includes almost all possible fault dips/azimuths and horizon dips.

In some embodiments, six steps are used to create a 3D synthetic image cube: 1) making a horizontal reflectivity model; 2) folding; 3) shearing; 4) faulting; 5) convolving with a wavelet; and 6) adding noise. The 3D training data cube may be set to be 32×32×32 samples. The center point of an image cube is labeled as a fault only if a fault plane passes through the center within a distance boundary of one sample and the fault slip is greater than one sample. In some embodiments, approximately 10,000, 25,000, 50,000, 100,000 or more 3D image cubes can be generated for each training data 110, 112, and 114. Likewise, in some embodiments, approximately 2,500, 5,000, 7,500, 10,000, or more 3D image cubes can be used for validation of the neural networks 92 and 94. Additionally, the synthetic training data chosen for each of the neural networks 92 and 94 can be balanced for the neural network 92 (e.g., the dip CNN models 100, 102, and 104 having 26 categories of outputs) and the neural network 94 (e.g., the azimuth CNN models having 37 categories of outputs).

FIG. 8 illustrates a CNN architecture 116 that can be used for each of the CNN model models 100, 102, and 104 (as well as for the CNN models of the neural network 94). Alternatively, it is envisioned that two or more different CNN architectures can be used in a given ensemble, for example, to take advantage of their diversified hypotheses. However, for discussion purposes, the same CNN architecture 116 of FIG. 8 is used for all three CNN models 100, 102, and 104 in the ensemble in neural network 92 (and the same CNN architecture 116 is used in the ensemble of neural network 94). However, as discussed above with respect to FIG. 7, each of the three models CNN models 100, 102, and 104 are trained with non-overlapping training data (datasets) 110, 112, and 114, respectively, that are generated separately.

The CNN architecture 116 of FIG. 8 includes twelve 3D convolutional (CONV) layers 118 using a uniform kernel size 3×3×3 for a given input data 119. The number of CONV channels starts at 16 and then doubles after every max pooling 120 (e.g., down sampling). A rectifier linear unit (ReLU) activation function 122 (e.g., a transfer function) is applied after every 2 CONV layers 118, and max pooling 120 is applied after every 4 CONV layers 118. A fully-connected (FC) layer 124 with 256 neurons connects the CONV layers 118 and the output layer 126 where a 50% dropout is applied after the FC layer 124 for regularization. In the output layer 126, a softmax classifier is used to output the probability associated with each category, where the max probability indicates the predicted category.

One or more embodiments of the present invention are directed to performing automated fault detection. One or more embodiments can perform automated fault detection within a three-dimensional subsurface volume. One or more embodiments can implement fault detection by using deep learning.

With one or more embodiments, the process of deep learning can be performed by training the system with synthetic training data. One or more embodiments can use training data in the form of 2-dimensional patches of data. One or more embodiments can use training data in the form of 3-dimensional cubes of data. With one example embodiment, a plurality of 32×32×32 cubes (e.g., 3D training cubes) can be used as training data.

In view of the above, one or more embodiments can provide a useful product that can guide interpreters and that can speed up the process of mapping faults. One or more embodiments can perform automated fault mapping at short notice (e.g., such as performing fault mapping for time-sensitive exploration projects). One or more embodiments can assist horizon and direct-hydrocarbon-indicator mapping.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A computer program embodied on a non-transitory computer readable medium, said non-transitory computer readable medium having instructions stored thereon that, when executed by a computer, which implements or operates in conjunction with a first neural network and a second neural network, causes the computer to perform:
receiving image data that is to be recognized by the first neural network and the second neural network, wherein the image data is representative of a subsurface volume;
generating a first output via the first neural network based on the image data;
generating a second output via the second neural network based on the image data;
comparing the first output with the second output to determine whether a fault is present in the image data; and
transmitting a third output indicative of a presence of the fault in the image data when the fault is determined to be present in the image data.

2. The computer program of claim 1, wherein the first neural network and the second neural network are portions of a single neural network.

3. The computer program of claim 1, wherein the first output is related to a. first aspect of the fault.

4. The computer program of claim 3, wherein the first aspect of the fault is a dip of the fault.

5. The computer program of claim 3, wherein the second output is related to a second aspect of the fault.

6. The computer program of claim 5, wherein the second aspect of the fault is an azimuth of the fault.

7. The computer program of claim 1, wherein the computer performs generating the first output in parallel with generating the second output.

8. The computer program of claim 1, wherein the computer performs comparing the first output with the second output b determining whether either of the first output or the second output comprise negative indication of whether the fault is present in the image data.

9. The computer program of claim 1, wherein the first neural network and the second neural network are each a Convolutional Neural Network (CNN).

10. The computer program of claim 9, wherein the first neural network and the second neural network each comprise an ensemble of multiple CNN models trained using unique training data for each CNN model of the ensemble of multiple CNN models.

11. The computer program of claim 10, wherein each CNN model of the ensemble of multiple CNN models comprises a common CNN architecture.

12. A device, comprising:
an input that in operation receives image data representative of a subsurface volume; and
a processor that in operation:
implements a first neural network to generate a first output based on the image data;
implements a second neural network to generate a second output based on the image data;
compares the first output with the second output to determine whether a fault is present in the image data; and
generates a third output indicative of a presence of the fault in the image data when the fault is determined to be present in the image data.

13. The device of claim 12, wherein the first output is related to a dip of the fault.

14. The device of claim 13, wherein the second output is related to an azimuth of the fault.

15. The device of claim 12, wherein the processor when in operation performs comparing the first output with the second output by determining whether either of the first output or the second output comprise negative indication of whether the fault is present in the image data.

16. The device of claim 12, Wherein the first neural network and the second neural network are each a Convolutional Neural Network (CNN).

17. The device of claim 16, wherein the first neural network and the second neural network each comprise an ensemble of multiple CNN models trained using unique training data for each CNN model of the ensemble of multiple CNN models.

18. The device of claim 12, wherein the processor when in operation assigns a probability can be assigned to the fault as the third output.

19. A method, comprising:
receiving image data representative of a subsurface volume;
selecting a first image as a subset of the image data;
generating a first output via a first neural network based on the first image;
generating a second output via a second neural network based on the first image, wherein each of the first neural network and the second neural network comprise a Convolutional Neural Network (CNN);
comparing the first output with the second output to determine whether a fault is present in the first image; and
generating a third output indicative of a presence of the fault in the first image when the fault is determined to be present in the first image.

20. The method of claim 19, comprising training an ensemble of multiple CNN models of the first neural network via unique training data for each CNN model of the ensemble of multiple CNN models.
